(19) United States
(12) Patent Application Publication
(10) Pub. No.: US 2020/0016873 A1
(43) Pub. Date: Jan. 16, 2020

(54) CROSS-LAMINATED TIMBER STRUCTURES HAVING REDUCED INNER-LAYER MATERIAL AND METHODS OF OPTIMIZATION

(71) Applicant: Massachusetts Institute of Technology, Cambridge, MA (US)

(72) Inventors: Caitlin Mueller, Somerville, MA (US); Paul Mayencourt, Cambridge, MA (US)

(21) Appl. No.: 16/511,662

(22) Filed: Jul. 15, 2019

Related U.S. Application Data
(60) Provisional application No. 62/698,029, filed on Jul. 14, 2018.

(51) Int. Cl. B32B 21/13; B27M 3/00; B32B 7/12

(52) U.S. Cl. CPC B32B 21/13; B27M 3/0086; B32B 7/12; B27M 3/006

(57) ABSTRACT

A cross-laminated timber (CLT) panel formed of multiple layers of alternating perpendicularly aligned lumber, where one or more portions of one or more inner layers are selectively removed and where one or more layers have a thickness different than one or more other layers of the CLT panel. Further, a system for optimizing the CLT panel by determining the design for the selective removal of one or more portions of one or more inner layers and, optionally, one or more varying layer thicknesses, provides a CLT panel with an improved stiffness to weight ratio and reduced material consumption.

### CROSS-REFERENCE TO RELATED APPLICATIONS

This application claims the benefit of U.S. Provisional Patent Application Ser. No. 62/698,029, filed Jul. 14, 2018, entitled “Hollow and Structurally Optimized Cross-Laminated Timber Panel,” which is incorporated by reference herein in its entirety.

### FIELD OF THE INVENTION

The present invention generally relates to improved cross-laminated timber (CLT) panels formed of multiple layers of lumber, each layer oriented perpendicular to adjacent layers, the CLT having reduced material consumption without significant change in structural behavior. More particularly, the present invention provides CLT panels and methods of optimization in which one or more portions of one or more inner layers are selectively removed and in which one or more layers have a thickness different than one or more other layers of the CLT.

### BACKGROUND OF THE INVENTION

It is estimated that the building sector is responsible for approximately 40-50% of greenhouse gas emissions in the United States (as reported by the U.S. Energy Information Administration, www.eia.gov). This contribution includes both the operational energy in buildings and the embodied energy in building materials and products. Two pathways have been extensively explored to reduce the ecological impact of building components: structural optimization and low embodied carbon building materials (C. Catherine E. L. De Wolf, “Low carbon pathways for structural design: embodied life cycle impacts of building structures,” Ph. D. in Building Technology, Massachusetts Institute of Technology, Department of Architecture, 2017, 1003322575).

Structural optimization techniques aim to achieve similar or improved structural performance while reducing the cost of construction or material usage for a given structural condition. In 1638, Galileo Galilei first described a technique to shape a beam following the moment diagram in order to reduce the amount of material needed to support a weight at the end of a cantilever. Computation has since then expanded the potential of structural optimization with numerical techniques for topology, shape and size optimization to find minimal weight or minimal compliance structural systems (W. R. Spillers and K. M. MacBain, Structural Optimization. Springer US, 2009).

Within common construction materials, it is difficult to define global low carbon building materials since their embodied energy depends on local technologies, availability of resources, or even on the sustainability assessment itself. However, material selection charts (M. F. Ashby, Materials Selection in Mechanical Design. Butterworth-Heinemann, 2016) together with accurate embodied carbon data from life cycle analysis (LCA) help designers navigate the decision process. A current study of the embodied energy of constructed buildings in more developed countries shows that when considering environmental metrics at the building scale, construction systems made out of timber or masonry display a lower ecological impact on average (C. Catherine E. L. De Wolf, “Low carbon pathways”). Wood more specifically is appreciated for its carbon storage capabilities, especially when sourced from sustainably managed forests (U. Dangel, Turning Point in Timber Construction: A New Economy, 1. edition. Basel: Birkhauser, 2016).

In the United States, timber construction is gaining interest with the construction of midrise timber buildings. These new timber constructions deploy recently democratized engineering wood products such as glue-laminated beams, cross-laminated timber (CLT) panels, or nail-laminated timber, differentiating itself from more traditional light-wood-frame construction, due to their inherent fire resistance. CLT panels are formed of glued together perpendicularly oriented layers of dimensional lumber (standardized sizes). Their improved dimensional stability due to the cross-layer buildup is particularly appreciated by the construction industry due to its high degree of prefabrication, which can speed up construction on site. Moreover, standard CLT panels can be used for two-way slabs as they can carry loads in both directions due to their cross lamination, and they can be used for walls as well.

However, despite their clear advantages at present, the manufacturing of CLT panels is not particularly efficient. A recent benchmarking study revealed that 59% of the manufacturing cost of cross-laminated timber panels is the raw material—wood (The Beck Group, California Assessment of Wood Business Innovation Opportunities and Markets, Phase 2 Report, 2015). Other studies demonstrate that this figure can be as high as 77% (B. Toosi, Cross Laminated Timber—The Market Opportunities in North America, 2011). Further, it has been found that floor systems using timber beams and CLT floors are often heavier than steel beams with concrete composite flooring. Further, most current projects use CLT in one-way systems, which do not take full advantage of the mechanical properties achieved through cross-layer construction.

In view of the great potential for CLT, further improvements in design, use, and manufacture would be desirable.

### SUMMARY OF THE INVENTION

According to one aspect, the present invention provides a CLT panel and method of making in which one or more inner layers of the CLT panel are partially modified, in particular, by selectively removing or eliminating one or more portions of one or more inner layers. In addition, one or more layers of the overall CLT panel may be further designed to have a thickness that is different than one or more other layers of the CLT. CLT panels and methods of making are further optimized so as to provide one or more removed portions and, optionally, one or more varying layer thicknesses, therein the optimization provides an improved stiffness to weight ratio of resulting CLT panel.

The present invention provides a method of forming a cross-laminated timber (CLT) panel. In accordance with one exemplary embodiment of the invention, the method comprises the steps of: providing a top timber layer, the top timber layer having a wood grain running along a length of the CLT panel; providing at least one inner timber layer disposed directly beneath the top timber layer, the at least one inner timber layer having a wood grain running perpendicular to the length of the CLT panel; providing a bottom timber layer disposed directly beneath the at least one inner timber layers, the bottom timber layer having a wood grain running along the length of the CLT panel; wherein the at least one inner timber layer is sandwiched between the top timber layer and the bottom timber layer; wherein the at least one inner timber layer comprises a plurality of components, the plurality of components being spaced apart from each other within the at least one inner layer; and wherein a thickness of the at least one inner timber layer is different from a thickness of at least one of a thickness of the top timber layer and a thickness of the bottom timber layer.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIGS. 1A-D schematically illustrate a prior art CLT panel and a CLT panel according to an embodiment of the present invention, where FIG. 1A shows a cross-section of a prior art CLT panel, FIG. 1B shows a section A-A view of FIG. 1A, FIG. 1C shows a cross-section of a CLT panel according to an embodiment of the present invention, and FIG. 1D shows a section B-B view of FIG. 1C.

FIGS. 2A-B schematically illustrate a prior art CLT panel and a CLT panel according to an embodiment of the present invention, where FIG. 2A shows a cross-section of a conventional panel in which all layers of the CLT are of equal thickness, and FIG. 2B shows a cross-section of an embodiment of the present invention in which multiple layers have different heights and varying relative removed portion densities (holes).

FIG. 3 schematically illustrates CLT panels according to an embodiment of the present invention analyzed as a sandwich panel with a core modeled as rectangular honeycomb solid and the outer wood layers as the sandwich panel's skin, wherein an abstraction of the CLT panel (bottom) is shown with cavities into a sandwich panel with a rectangular honeycomb core (top).

FIG. 4 schematically illustrates the structural mechanics model and parameters.

FIG. 5 schematically illustrates a load test setup.

FIG. 6 graphically depicts the stiffness against relative density of the transverse or cross-layers of a CLT panel according to an embodiment of the present invention based on the rectangular honeycomb model.

FIG. 7 graphically depicts the stiffness to weight ratio against relative density of the transverse or cross-layers of a CLT panel according to an embodiment of the present invention based on the rectangular honeycomb model.

FIG. 8 graphically depicts the stiffness to weight ratio as a function of the relative density of the transverse or cross-layers of a CLT panel according to an embodiment of the present invention.

FIG. 9 graphically depicts the critical force design for different CLT panel compositions according to embodiments of the present invention as a function of the relative density. The CLT panels are limited by the deflection limit.

FIG. 10 graphically depicts a comparison of the results for stiffness-to-weight ratio as a function of relative density of the cross-layer from the two models for 5-ply CLT panels according to embodiments of the present invention.

FIG. 11 graphically depicts test result for six specimens, with the solid lines showing the load test data of the standard panel (‘FULL’), and the dotted lines showing the results for the optimized panels (‘OPTI’).

FIG. 12 illustrates various failure modes of CLT panels according to embodiments of the present invention, with failure of panel OPTI1 (top left and right images), failure of OPTI2 (bottom left), and failure of OPTI3 (bottom right), and where the box ‘1’ shows the failure of a cross element with good glue bonding, and boxes ‘2’ and ‘3’ show zones where the glue did not adhere to the wood, as the rupture did not leave any wood fibers behind.

FIG. 13A-B illustrate tension rupture on the face of conventional CLT panels.

FIG. 14 schematically illustrates a result of the layout optimization for CLT panels with equivalent stiffness, wherein for the same structural depth and stiffness, the CLT panel layout on the right, which is in accordance with the present invention, is 18% lighter than a conventional CLT panel on the left.

FIG. 15 schematically illustrates possible coupling of an optimized CLT panel in accordance with an embodiment of the present invention, with concrete topping and post-tensioning elements.

FIG. 16 is a flowchart illustrating a method performed by the present system for providing cross-laminated timber panels having reduced inner-layer material.

### DETAILED DESCRIPTION

The following definitions are useful for interpreting terms applied to features of the embodiments disclosed herein, and are meant only to define elements within the disclosure.

As used herein, the term “outer layers” when used to describe the outer layers of a CLT panel, refers to the outermost layers of the CLT panel. As such, the term “outer layers” refers to the bottom layer and top layer of the CLT panel.

As used herein, the term “inner layers” or “innermost layers” refers to all layers of a CLT panel disposed between the outer layers. As used herein, the terms “longitudinally extending layer” or “longitudinal layer” refers to layers of the CLT panel having a wood grain that extends lengthwise along the CLT panel, and will generally comprise the sequentially odd numbered layers beginning with a first layer (layer 1) positioned at the top of the CLT panel, the sequential layers after the first uppermost layer being numbered 2, 3, 4, etc. Longitudinal layers are also referred to as the major axis direction. Generally, CLT panels have an overall rectangular shape and, thus, the longitudinally extending layers/longitudinal layers are those layers which are aligned along the direction of the CLT panel's largest dimension (along the CLT panel's length).

As used herein, the terms “transversely extending layer”, “transverse layer”, or “cross-layer” refers to layers of the CLT panel having a wood grain that extends perpendicular to the length of the CLT panel (and, thus, also perpendicular to the longitudinal layers), and will generally comprise the sequentially even numbered layers beginning with a second layer positioned directly below and adjacent the top layer of the CLT panel. Generally, CLT panels have an overall rectangular shape and, thus, the transversely extending layers/transverse layers/cross-layers are those layers which are aligned along the width of the CLT panel. Thus these layers may be described as those extending in the minor axis direction. As used herein, the terms “optimized” and “optimization” when referring to CLT panels in accordance with the present invention, sometimes referred to as “optimized panels”, “optimized CLT panels”, particularly in connection with the testing of CLT panels, refers to CLT panels in which one or more portions of one or more inner layers are removed, and in which there is improvement of the stiffness to weight ratio of CLT panels. A higher stiffness to weight ratio performance of the CLT panel means that the material is used more efficiently for the desired goal and, thus, a more optimized CLT panel. This optimization may further include varying layer thickness of the CLT panel such that the thickness of one or more layers of the CLT panel is different than the thickness of at least one other layer of the CLT panel.

As used herein, the term “selective removal” or “selectively removed” when referring to one or more portions of one or more inner layers of the CLT panel being “removed” refers to a structure wherein such an inner layer does not extend entirely between two adjacent layers but, rather, wherein there are one or more holes of openings within that layer. Such removed portions may include an overall rectangular hole or opening extending along the entire length of the CLT panel such that the layer is formed of a plurality of components (e.g. strips of timber) spaced apart from each other. However, such removed portions may also include other shaped holes or openings that may or may not extend along the entire length of the CLT panel. For example, the holes or openings may vary along the length of the CLT panel in a tapered shape. Also included are holes or openings that vary along the length of the panel in any pattern such as, for example, wherein the size of the hole or opening gradually increases from a center portion of the CLT panel (longitudinally centered) towards the ends of the CLT panel to reflect the change of external loads. In some cases, fewer or smaller holes or openings at the ends of the CLT panel may provide better resistance.

The present invention provides an improved CLT panel and method of optimization which is designed to reduce material consumption, decrease costs, and increase efficiency. The CLT panel includes at least three orthogonally bonded layers of lumber, particularly wherein at least three layers are laminated by gluing or adhering alternating longitudinally extending and transversely extending adjacent layers of lumber together to form a generally rectangular planar CLT panel structure. The bonding of layers can be accomplished using any conventional bonding technique and materials. Two outer layers, formed of the top layer and bottom layer, sandwich one or more inner layers, and one or more portions of one or more of these inner layers are selectively removed. In some embodiments, the CLT panel may further be provided with at least one of the multiple layers (the multiple layers including both the outer layers and all of the inner layers) having a thickness that is different than the thickness of at least one or more of the other layers of the CLT panel.

In particular, it was determined that the inner layers (wherein the inner layers may sometimes be referred to as the “core”) of a CLT panel do not significantly contribute to the structural properties, particularly bending stiffness and bending strength, of the overall CLT panel, which is mostly controlled by the outer layers. Rather, the inner layers act primarily as a spacer between the outer layers. As such, removal of one or more portions of one or more of the inner layers provides reduced material consumption without compromising the desired structural properties of the resulting CLT panel.

According to an embodiment of the present invention, a theoretical model for the behavior of optimized CLT panels was developed to determine an improved CLT structural design with reduced inner layer material, while at the same time, significantly maintaining the structural properties of the CLT panel to within acceptable limits. Such “acceptable limits” are determined by the user of the algorithm/optimization outlined herein and, thus, can vary depending upon the desired end use of the CLT panels and the required structural properties.

According to embodiments of the present invention, two different approaches were used to model the modification of the CLT inner layers. The first approach is based on structural mechanics theory. The second approach uses cellular material theory to model the core or inner layers of the CLT panel, since the network of wood longitudinal layers and transverse layers can be modeled as a square honeycomb core of a sandwich panel. Based on this, a theoretical model was developed and compared with scaled physical load tests. The results of the scaled physical load tests demonstrated that the theoretical model developed herein accurately predicts physical behavior for the present invention CLT panels. The two models and theoretical model development, as well as the scaled physical load tests are described further below.

Reference will now be made in detail to embodiments of the present invention, examples of which are illustrated in the accompanying drawings. Wherever possible, the same reference numbers are used in the drawings and the description to refer to the same or like parts.

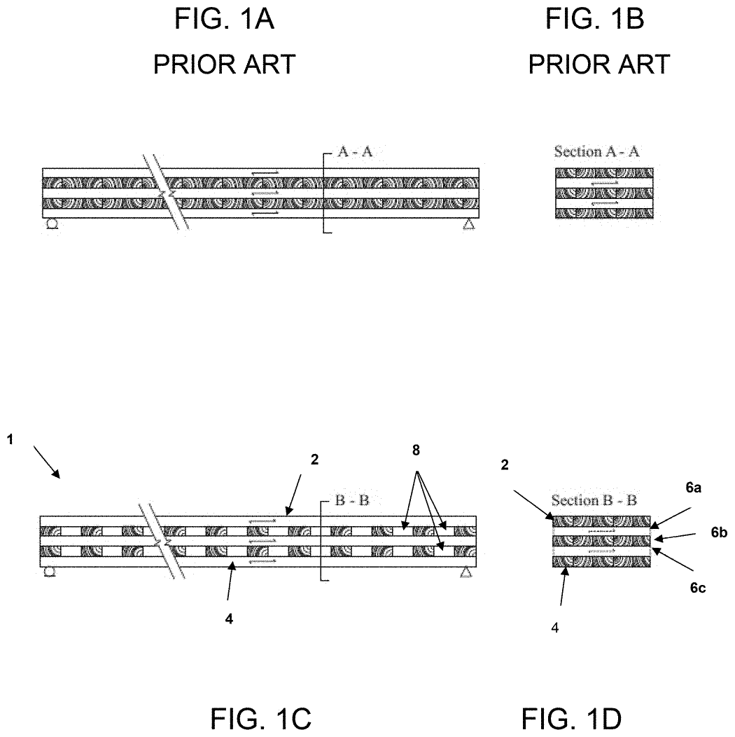

According to an embodiment of the present invention, as schematically depicted in FIG. 1C-D, a CLT panel 1 is provided with multiple layers of lumber, with a top 2 and a bottom layer 4, together forming outer layers, and all layers 6a, 6b, 6c in between the top and bottom layers 2, 4 forming inner layers. In this embodiment, the total number of layers is five, however, the present invention is not limited as such. In particular, the present CLT panel 1 can include any number of layers of three or greater, with exemplary structures including three layers, five layers (as shown in FIG. 1B) and seven layers. It is noted that CLT panels are typically provided with an odd number of total layers. However, while this will typically be the case in the present invention CLT panel structures, the present invention is not limited as such, and may be provided with an even total number of layers if desired. While three, five and seven layer structures are generally utilized in CLT panels, according to various embodiments of the present invention, the multiple number of layers can range from three all the way up to and including eleven layers. While it is physically possible to provide larger numbers of layers, this is generally not economically viable. As depicted in FIGS. 1C-D, alternating adjacent layers 2, 6a, 6b, 6c, 4 are oriented perpendicular to each other, with the wood grain of 2, for example, extending in a longitudinal direction, the wood grain of 6a extending a transverse direction, the wood grain of 6b extending in a longitudinal direction, and so on. As depicted in FIG. 1C, one or more portions 8 of inner layers 6a and 6c are selectively removed to reduce material use. In the exemplary embodiment shown in FIG. 1C, portions 8 are removed only from alternating inner layers 6a and 6c. Thus, inner layer 6b does not have removed portions 8. However, this removal of one or more portions 8 from alternating inner layers (e.g., layers 6a and 6c but not 6b) is not limiting, and in some embodiments, one or more portions 6 may be removed from all of the inner layers, from one or more directly adjacent layers, or from only one or two (depending upon whether there are a total multiple of layers that are even or odd) central inner layers, etc. Further, as shown in this embodiment, approximately 50% of layer 6a and layer 6c is removed in evenly spaced increments, with each portion 8 being equal in size. However, the one or more portions 8 need not be evenly spaced within the one or more layers, and the one or more portions 8 need not be of equal/uniform size. Further, the percent of layer removal is not limited to 50%. According to embodiments of the invention, the percent of layer removal from a single inner layer can vary widely and is determined by the end user. For example, a percent of removal of as low as about 2 or 3% may provide benefit in some applications, and a percent of removal greater than 50%, and even up to about 80% may provide benefit in other applications.

It has been found that not only does removal of one or more portions of one or more inner layers reduce material use, but such removal also beneficially improves the stiffness to weight ratio.

According to another embodiment of the present invention, the CLT panel 1 is provided with multiple layers (wherein the multiple layers include all of the CLT layers, both outer and inner layers), wherein at least one of the multiple layers has a thickness different than at least one of the other layers. According to various embodiments, two or more layers have varying thicknesses. This varying layer thickness structure can be provided in combination with the above-described removed portion 8 features described in connection with FIGS. 1A-D. In particular, a CLT panel 1 having at least one of the multiple layers with a thickness different than the thickness of one or more other layers can include one more portions 8 of one or more inner layers selectively removed. These portions 8 can be evenly spaced along the layer and can be equal in size, or they can be unevenly spaced within the one or more layers and/or may be of varying size.

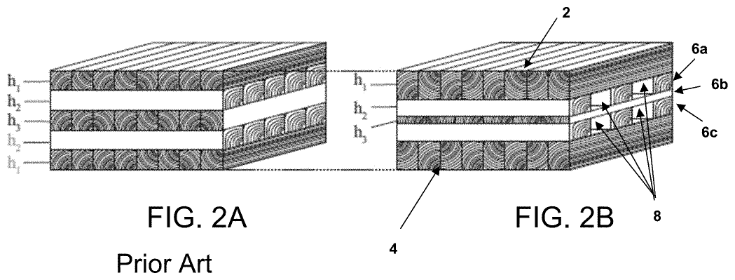

As shown in FIG. 2A, a conventional CLT panel contains five layers, wherein two outer layers have the same thickness h₁, two inner layers adjacent the two outer layers have the same thickness h₂, and one central inner layer has a height h₃. All of these layers may further have equal height, with h₁=h₂=h₃. FIG. 2B depicts an embodiment of the present invention in which the top layer 2 and bottom layer 4 have the same thickness h₄, the two inner layers 6a and 6c have the same thickness h₅, and the central inner layer 6b has a thickness h₆, wherein h₄≠h₅≠h₆. According to other embodiments, additional inner layers may be included which have thicknesses different than h₄, h₅, and/or h₆, or which have thicknesses equal to one or more of h₄, h₅, and/or h₆. When comparing the structure of FIGS. 2A and 2B as depicted, for the same structural depth and stiffness, the structure of FIG. 2B is about 18% lighter and about 10% cheaper.

As set out, according to the present invention, two different models were used to describe the behavior of an optimized CLT panel. Based on the theory of sandwich panels and cellular solids materials theory (See L. J. Gibson and M. F. Ashby, Cellular Solids: Structure and Properties. Cambridge University Press, 1999), which is incorporated herein by reference in its entirety, the first strategy models the core (i.e., all inner layers) of the CLT panel 1 as a square honeycomb structure and the outer layers (top layer 2 and bottom layer 4) as a wood skin. The second model is based on the theory of structural mechanics, wherein the change in section properties (i.e., the change in properties of one or more inner layers of the CLT panel) provides an updated moment of inertia.

Timber structures are generally designed for the serviceability limits, meaning that the stiffness is the most important factor. For this reason, the influence of selectively removing one or more portions of the inner layer(s) on the stiffness of a CLT panel is studied throughout the different models. In the context of these models, the term “optimization” refers to the improvement of the stiffness to weight ratio of the CLT panels. A higher stiffness to weight ratio performance of the CLT panel means that the material is used more efficiently for the desired goal.

### Cellular Solids Model

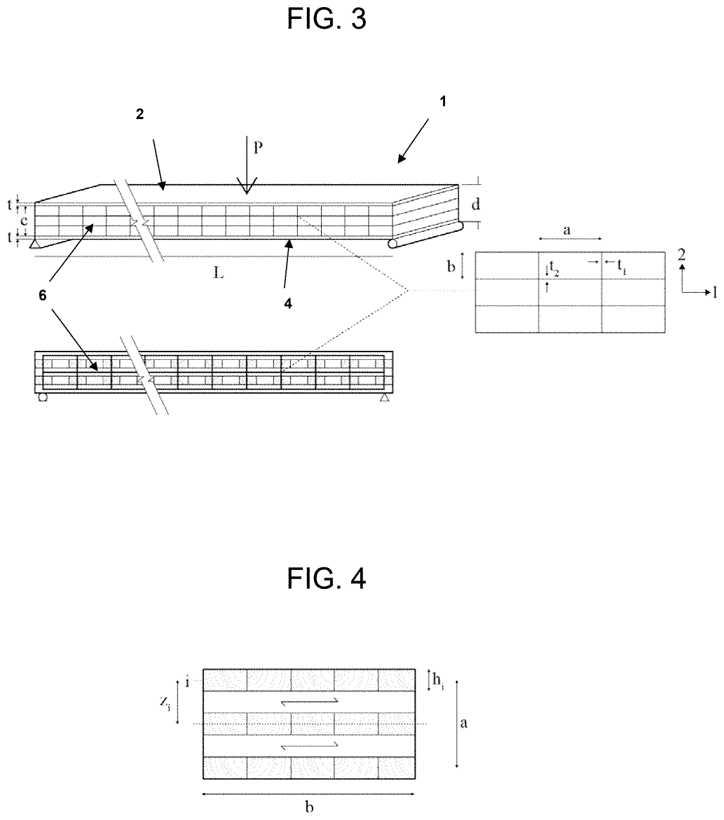

According to an embodiment of the present invention, the theory of cellular solids and sandwich panels are used to model optimizing the structural behavior of CLT panels. The general theory of sandwich panels offers a set of analytical equations to optimize the structure of sandwich panels with known core and skin properties. The equations are typically used to design sandwich panels to target stiffness (also referred to as compliance) to minimize the weight of the panels. Applying the sandwich panel theory, we separate the behavior of the core (i.e., the inner layers 6a, 6b, 6c, etc., collectively depicted in FIG. 3 as core/inner layers 6) of the CLT panel 1 and the behavior of the skin (i.e., outer layers formed of the top and bottom layers 2, 4) of the CLT panel 1. As depicted in FIG. 3, the core/inner layers 6, of the CLT panel 1 is represented as a rectangular honeycomb.

In order to model the behavior of the sandwich panel, the properties of the core/inner layers 6 and skin (top and bottom layers 2, 4) need to be known. Due to its honeycomb structure, the properties of the top and bottom layers 2, 4 differ from the behavior of the material it is made from. These properties in directions 1 and 2 (see FIG. 3) are analogous to the in-plane properties (E₁*, G₁₂*) of a rectangular honeycomb. The in-plane properties of a rectangular honeycomb with dimensions a, b, t₁ and t₂ (as shown in FIG. 3) are derived in A. M. Hayes, A. Wang, B. M. Dempsey, and D. L. McDowell, “Mechanics of linear cellular alloys,” Mech. Mater., vol. 36, no. 8, pp. 691-713, August 2004, which is incorporated by reference herein in its entirety, and they can be used in this model with the material properties of wood.

For rectangular honeycombs, the relative density is: ρ*/ρₛ=(at₂+bt₁)/ab. This is an approximation, which applies if a>>t₁ and b>>t₂. This assumption clearly does not hold for a CLT panel, as this would result in relative densities that are greater than 1, which has no physical meaning. However, since b=2t₂, the equation can be rewritten, resulting in the equation shown below:

$$\begin{matrix}Relative density \text{:} \frac{{ρ}_{c}^{*}}{{ρ}_{s}} = \frac{a + 2 {t}_{1}}{2 a} & ( 1 ) \\ Young \text{’} s modulus \text{:} {E}_{1}^{*} = \frac{{t}_{1}}{a} {E}_{s , parallel} & ( 2 ) \\ Shear modulus \text{:} {G}_{12}^{*} = \frac{{t}_{1}^{3} {t}_{2}^{3}}{2 {at}_{2} ( {at}_{1}^{3} + 2 {t}_{2}^{4} )} {E}_{s , perpendicular} & ( 3 ) \\ Weight \text{:} W = {ρ}_{c}^{*} ℊ {wlxt}_{2} & ( 4 )\end{matrix}$$

where w=width of the layer, l=span of the panel, ρ*_{c}=density of the panel and x=number of plies.

The compliance of the CLT panel under three-point bending with central load P is then given by its bending and shear contribution: δ/P=l³/B₁(EI)_{eq}+l/B₂(AG)_{eq} (See L. J. Gibson and M. F. Ashby, Cellular Solids: Structure and Properties. Cambridge University Press, 1999). Taking (EI)_{eq}=E_{f}btd²/2 and (AG)_{eq}=wcG*₁₂, the compliance can then be approximated as:

δ/P=2l³/B₁E_{f}w^{t}^{₂}/₂(xt₂)²+l/B₂wxt₂G*₁₂ (5)

The set of presented equations (1)-(5) describes the structural behavior of a CLT panel modeled as a sandwich panel with a rectangular honeycomb core. The control parameter, here defined as the relative density of the core, modifies the CLT panel's performance and weight.

### Structural Mechanics Model

In the structural mechanics model, the structural behavior of a CLT panel is based on the US CLT Handbook (E. Karacabeyli and B. Douglas, US CLT Handbook. FPInnovations, 2013) and on the design guide for CLT after the Eurocode 5 (M. Wallner-Novak, J. Koppelhuber, and K. Pock, Brettsperrholz Bemessung: Grundlagen für Statik and Konstruktion nach Eurocode: Informationen für die Berechnung and konstruktive Gestaltung von Holztragwerken. Wien: ProHolz Austria, 2013), which are incorporated herein by reference in their entirety. In this model, the stiffness of a panel is derived from a combination of the shear stiffness (mainly influenced by the cross layer) and the bending stiffness, which takes its biggest contribution from the longitudinal layers. The model was used to derive the stiffness and strength of the present invention modified CLT panels (see FIG. 4 and equations (6)-(12) below).

Here, a new parameter: the relative density ρ*/ρₛ of the core (equation (6)), similarly defined as in the previous model, is introduced into the equation as a modifier of the contribution of each layer of the CLT panel. In this case, only the transverse/cross-layers (as previously noted, these comprise the “even” layer numbers with the top layer 2 of a CLT panel being layer 1, the next sequential layer being layer 2, etc.) get their relative densities modified. As an example, a relative density of 1.0 corresponds to a standard CLT panel with complete/unmodified transverse layers (thus, a “standard CLT panel” refers to a conventional CLT panel in which none of the inner layers have any portions removed). A relative density of 0.5 would mean that half of the transverse layer is removed. For example, every other element of the transverse layers may be removed as shown in the examples depicted in FIGS. 1B and 2B to provide a relative density of 0.5. For simplification of the notation of the following equation, we have:

$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness \text{:} {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness \text{:} {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness \text{:} {EI}_{app} = \frac{{EI}_{eff}}{1 + \frac{{K}_{s} {EI}_{eff}}{{GA}_{eff} {L}^{2}}} & ( 9 ) \\ Bending strength \text{:} {F}_{b} {S}_{eff} = {F}_{b} \frac{2 {EI}_{eff}}{{E}_{1} h} & ( 10 ) \\ Shear strength \text{:} {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight \text{:} w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$

Where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions (14.4 in the case of simply supported beam), F_{b}=allowable bending stress, E₁=stiffness parallel to the grain and F_{S}=allowable rolling shear stress.

### Physical Load Testing

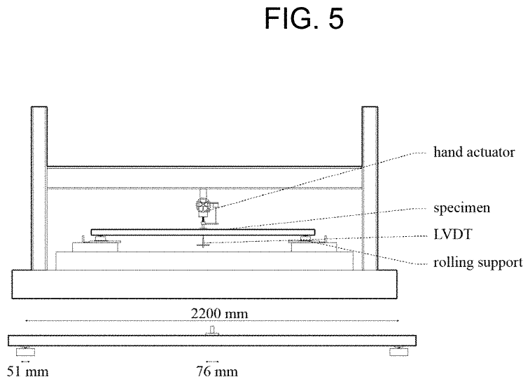

To test the two above-described analytical models developed to model the present invention CLT panel, three control panels and three test panels with cavities were load-tested for failure load and stiffness using the load test setup depicted in FIG. 5. The six specimens were tested in three-point bending. The test panels have a cross-section of 30 mm (height) by 60 mm (width) and were loaded at mid-span. The distance between the supports in the load test setup was 1.1 m.

The loading was controlled by the displacement of a manual actuator. The displacement at the center of the span, under the load application location, was measured on the bottom surface of the panel with a Linear Variable Differential Transformer (LVDT) (See FIG. 5)

The tested panels were scaled-down versions of existing industrial North American 5-ply CLT panels (Nordic Structures 175-5s; Nordic Engineered Wood, “Nordic X-Lam—Nordic Engineered Wood, Non-residential Design, Construction Guide.” 2015). The tested CLT panels in accordance with the present invention had a relative density of the core layers (inner layers 6a, 6b, 6c) equal to 0.5, so that every other piece was removed. The specimens were loaded in three-point bending for a span of 1.1 m and had a cross-section of 30 mm width by 60 mm height. Each layer of the CLT panel had a height of 6 mm. The panels were fabricated with 38.1 mm by 140 mm boards of Select Structural grade Douglas Fir-Larch, the highest visual structural grade with characteristic material properties published by the National Design Specification (American Wood Council, National Design Specification 2018—Supplement—Design Values for Wood Construction. American Wood Council, 2017). However, the material characteristics could not be used directly to predict the strength of the scaled down panels because of the scale of the wood elements (6 mm by 12 mm). Since the load testing aims to compare changes in structural stiffness between two panels, the material properties for this scale were not characterized. Testing wood specimen of this size does involve scale effects. They were, however, not taken into account since the test compares the relative performance between the two designs made out of the same material and at the same scale.

The lumber boards were cut into thin lamella of rectangular cross-sections of 6 by 12 mm on a band saw and then on a table saw. Each layer of the fabricated panels was first edge-glued to produce one longitudinal layer of the sandwich panel. Then, the layers were individually glued together with small wooden elements of the cross layer. In the case of the panel with cavities, a plywood jig was cut on the CNC-router mill for accurate positioning of the crosspiece. Once the assemblies of one cross-layer and longitudinal layer were produced, they were stacked and glued together to form 5-layer CLT panels. A wood glue, Titebond III (www.titebond.com/titebond_wood_glues/Ultimate_Wood_Glue.aspx), was used for the lamination of the layers. This glue has a longer working time needed for the accurate positioning of layers during assembly. Finally, the CLT panels were trimmed down to their final desired size on a table saw.

The results of the layout optimization for the present invention CLT panels will be described next. Conventional CLT panels were built with constant layer heights. Using the models developed in accordance with the present invention, a layout optimization of the present invention CLT panel was performed. The primary goal was to minimize the material use by varying the densities of the inner layers 6a, 6b, 6c as well as the thicknesses of the multiple layers 2, 4, 6a, 6b, 6c while keeping the stiffness of the panel to a within a target stiffness. This target stiffness is a value determined by the user and can be based on the end use of the CLT panel. The optimization process will, thus, vary the layer thickness and/or density of one or more cross-layers to obtain the target stiffness value. In some end uses, if stiffness is not an important factor, it might be set to a relatively low value (e.g., as compared to a conventional unmodified CLT panel).

The results due solely to the introduction of the cavities (i.e. portions 8 removed from one or more inner layers 6a, 6b, 6c), without providing the CLT panel with variable layer thicknesses, is presented in the results section of the individual models.

In order to reduce the number of variables, the problem was defined with a symmetry axis about the neutral axis of the CLT panel cross-section. In the context of the tests performed and results provided herein, the optimization was performed for a 5-ply CLT panel (i.e. 5 layered CLT panel, which includes both the top and bottom layers 2, 4), as a 5-ply panel configuration is the one that is used most for standard applications. A conventional 5-ply CLT panel spans a length between 4 and 6.5 m for a variety of common building loads (Nordic Engineered Wood, Nordic X-Lam—Nordic Engineered Wood, Non-residential Design, Construction Guide, 2015). The total depth (i.e. thickness) of the optimized CLT panel according to the present invention was kept the same as the initial standard panel (in the example, 175 mm). In the case of a 5-ply panel, three design variables were required for the layer thicknesses and one design variable for the relative densities of the cross-layers.

The volume minimization problem is subject to the following constraints (equations (13)-(17)):

$$\begin{matrix}α * {EI}_{app , initial} \leq {EI}_{app} & ( 13 ) \\ L \leq {L}_{crit} = \frac{1}{12.05} \frac{{EI}^{0.293}}{ρ {A}^{0.122}} & ( 14 ) \\ {h}_{1} \geq {d}_{fire} & ( 15 ) \\ {V}_{rd} \geq \frac{1}{2} \frac{48 {EI}_{app}}{360 {L}^{2}} & ( 16 ) \\ {h}_{1} + 2 {h}_{2} + 2 {h}_{3} \leq {h}_{max} & ( 17 )\end{matrix}$$

where Iₐₚₚ is the apparent bending stiffness of the structure as defined in connection with FIG. 4 and equation (9) above, a a modifier for the target stiffness, L_{crit} the critical span at which vibration problem start to appear, d_{fire} the minimal required thickness for fire resistance using a charring method, V_{rd} the shear resistance, L the span of the panel and hₘₐₓ the total height of the panel.

The geometrical variables were bounded such that the height of individual layers varied between 12.7 mm and 152 mm and the relative density of the cross-layers varied between 0.2 and 1.

The parameter a in equation (13) defines the constraint on the target stiffness. A value of 1.0 would require the stiffness of the initial standard panel to be the same as the resulting material efficient solution. Setting this parameter to a value lower than 1.0 provides options with high material savings.

A simplified procedure was used for the control of the vibrations (equation (14)) and fire safety (equation (15)). The vibration limit was compared to a critical span (as defined in E. Karacabeyli and B. Douglas, US CLT Handbook. FPInnovations, 2013) by the stiffness, the mass of the panels, and a structural system parameter. For fire safety, a simplified char design was used. In this case, the depth of the outer layers was set larger than the required char depth, which was set as a constraint. In this case, the minimum depth for the fire resistance d_{fire} was set to 30 mm. The shear resistance of the panel was set so that it was larger than the load that produces the maximal displacement allowed (equation (16)). The initial layer thickness was set to 35 mm.

The optimization was solved using fmincon in MATLAB (The MathWorks, MATLAB: “Matlab 2016b.” 2016) The material properties for the layout optimization were standard and taken from the example in the US CLT handbook [39], given in T:

TABLE 1
Material properties for the numerical application.

| Major strength axis parallel | | | Minor strength axis perpendicular | | |
|---|---|---|---|---|---|
| to the grain | | | to the grain | | |
| Bending | 13.4 | N/mm² | Bending | 3.44 | N/mm² |
| strength, | | | strength, | | |
| Fb, 0 | | | Fb, 90 | | |
| Modulus | 11,700 | N/mm² | Modulus | 8,273 | N/mm² |
| of | | | of | | |
| elasticity, | | | elasticity, | | |
| E0 | | | E90 | | |

| | | |
|---|---|---|
| Tensile | 9.48 | N/mm² |
| strength, | | |
| Ft, 0 | | |
| Compression | 12.4 | N/mm² |
| strength, | | |
| Fc, 0 | | |
| Shear | 0.93 | N/mm² |
| strength, | | |
| Fv, 0 | | |
| Rolling shear | 0.31 | N/mm² |
| strength, | | |
| Fs, 0 | | |

Results—Sandwich Panel with Rectangular Honeycomb Model

The influence of the relative density of the transverse/cross-layers was explored for values between 0 and 1. As described previously, 1 represents a non-modified cross-layer, 0.5 represents the removal of every other element of the cross-layer. The results are shown for 3-, 5-, 7-, 9-, and 11-ply CLT panels.

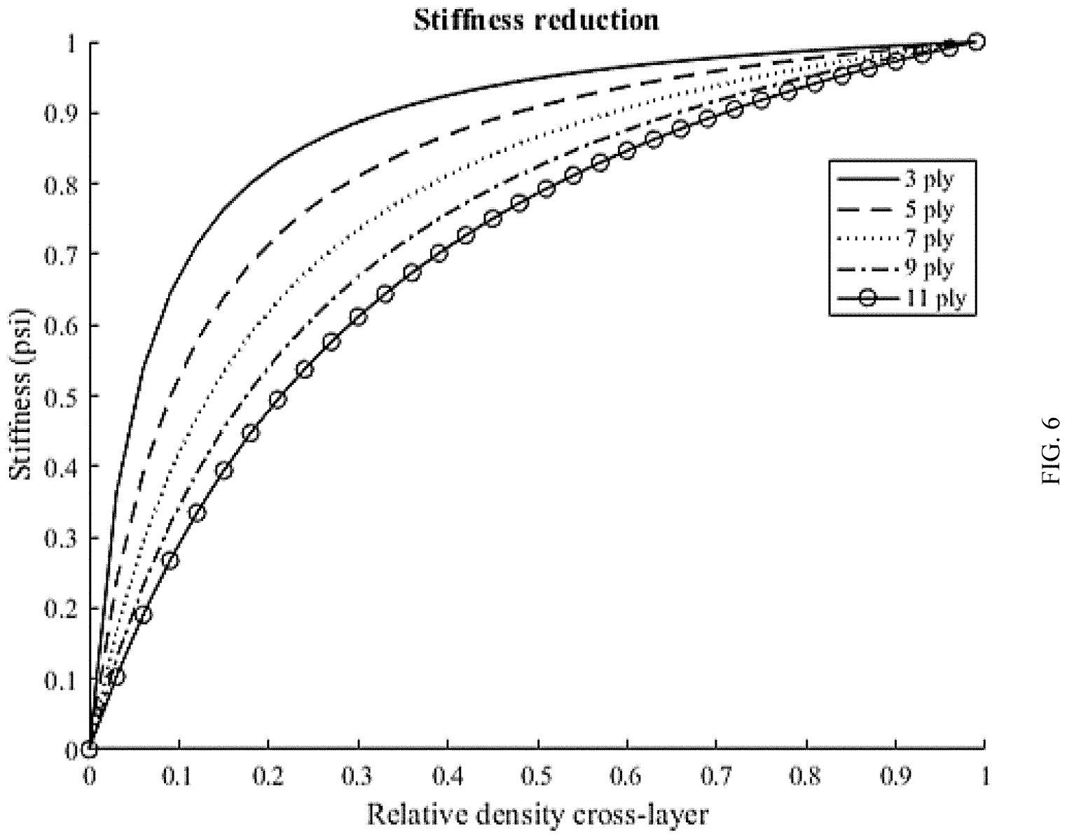

The graph in FIG. 6 plots the relative density of the cross-layer against the change in stiffness. Globally, a reduction of the relative density of the cross-layer reduced the stiffness of the panel. The change of stiffness has two main regions, with two different slopes. The first region, for relative densities between 0.5 and 1, has a flatter slope than the region between relative densities between 0 to 0.5. This change displays the growing influence of the shear deformation caused by the removal of the cross-layer.

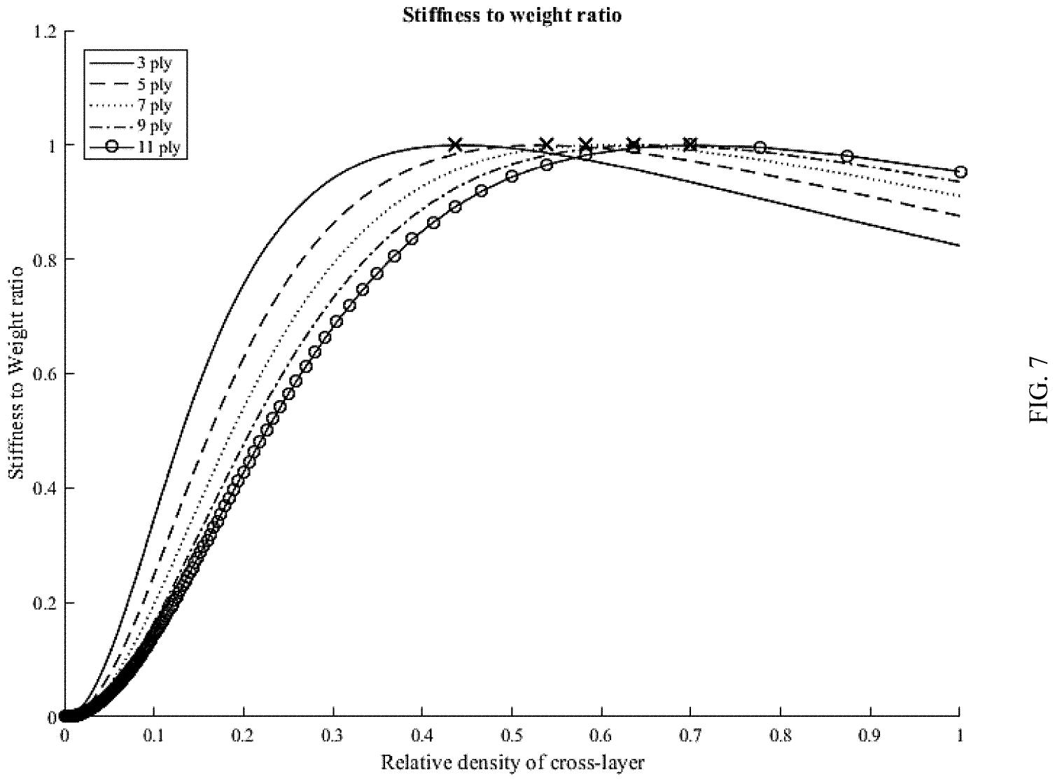

When combined with the reduction in weight due to the removal of the cross-layer, the stiffness-to-weight ratio in relation to the change of the relative density of the cross-layer was plotted, as shown in FIG. 7. Here, the graph also has two distinct regions, with different slopes. In this case, however, the slopes have opposite signs. The optimal value for this metric lies below 1. In other words, the CLT panels were demonstrated to have a better stiffness-to-weight ratio when some of the transverse/cross-layer elements were removed. The optimal values for the cross-layer densities are presented in

TABLE 2
Optimal relative densities for different panel compositions,
rectangular honeycomb panel model.

| 3-ply | 5-ply | 7-ply | 9-ply | 11-ply |
|---|---|---|---|---|
| 0.44 | 0.53 | 0.58 | 0.63 | 0.70 |

### Results—Structural Mechanics Model

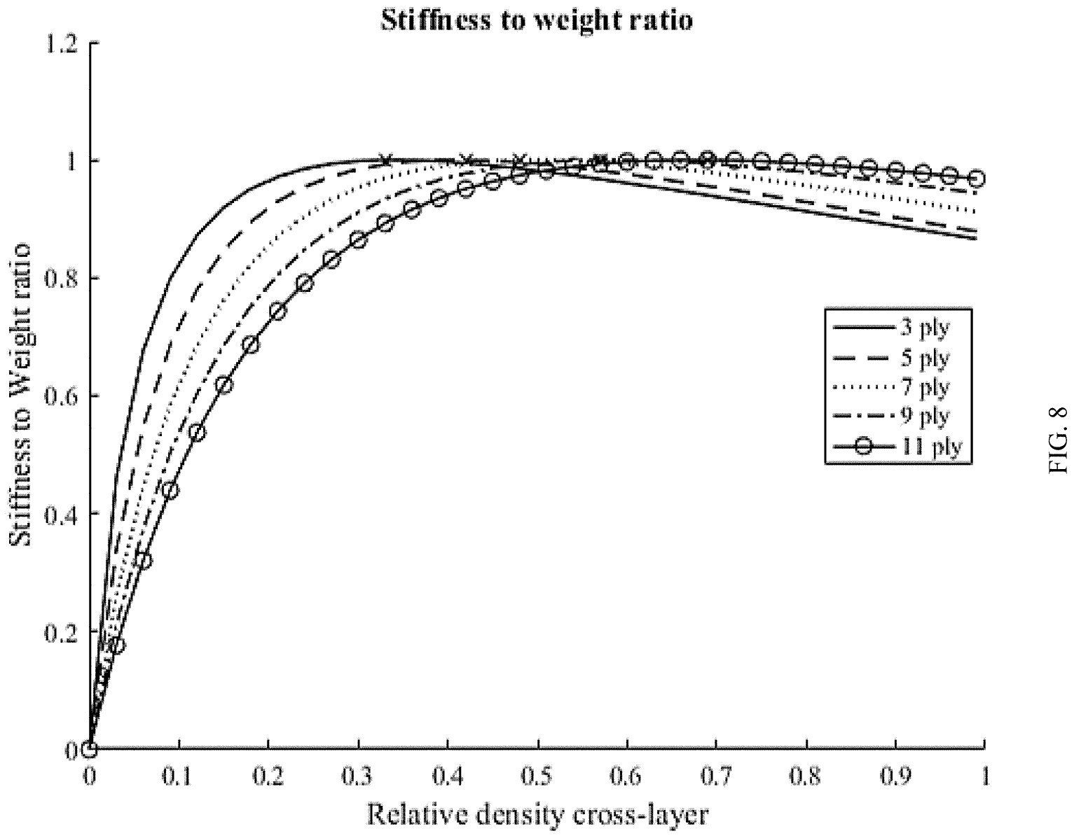

The same results as discussed in connection with the sandwich panel model above are presented for the second model based on structural mechanics. The stiffness-to-weight ratio is graphed in FIG. 8. The change of the relative density of the core displays the same influence on the behavior of the CLT panel. While removing some of the inner layer elements reduced the stiffness of the CLT panel, the rate of reduction in weight was greater for the relative densities for values between about 0.5 and 1. The optimal values for the highest stiffness to weight ratio are shown in Table 3 below.

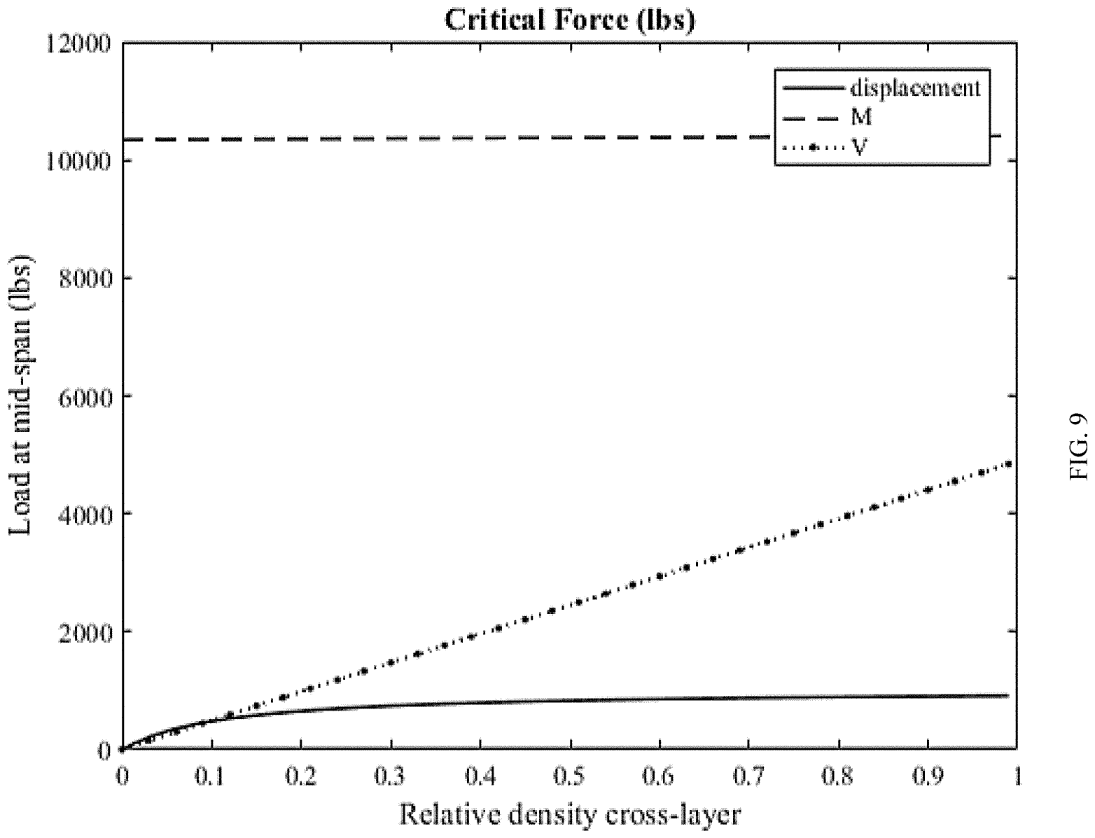

While the shear strength decreases with the reduction of one or more portions of the CLT inner layers, it was demonstrated that the deflection will always be the governing criteria in CLT design according to the present invention. FIG. 9 plots the force that corresponds to the limiting criteria for every relative density of the CLT inner layers. The curve for the displacement limit (here defined as L/360) is always located below the shear criteria (V) and the bending resistance (M). That means that even if the shear resistance is reduced when the inner layer portions are gradually removed, the shear resistance of the CLT panel will not govern the design. The deflection limit will be the limiting criteria for the design. Thus, further optimization as set forth in the next section focuses on the stiffness to weight ratio rather than the strength of the CLT panel. Results for different CLT layer thicknesses and plies show a similar outcome.

TABLE 3
Optimal relative densities for different panel
compositions, structural mechanics model.

| 3-ply | 5-ply | 7-ply | 9-ply | 11-ply |
|---|---|---|---|---|
| 0.34 | 0.41 | 0.49 | 0.58 | 0.68 |

The other mechanical properties of the CLT panel vary as expected from the equations defined earlier. The bending strength of the CLT panel remained almost constant throughout the variation of the relative density, and the shear strength varied linearly with the relative density.

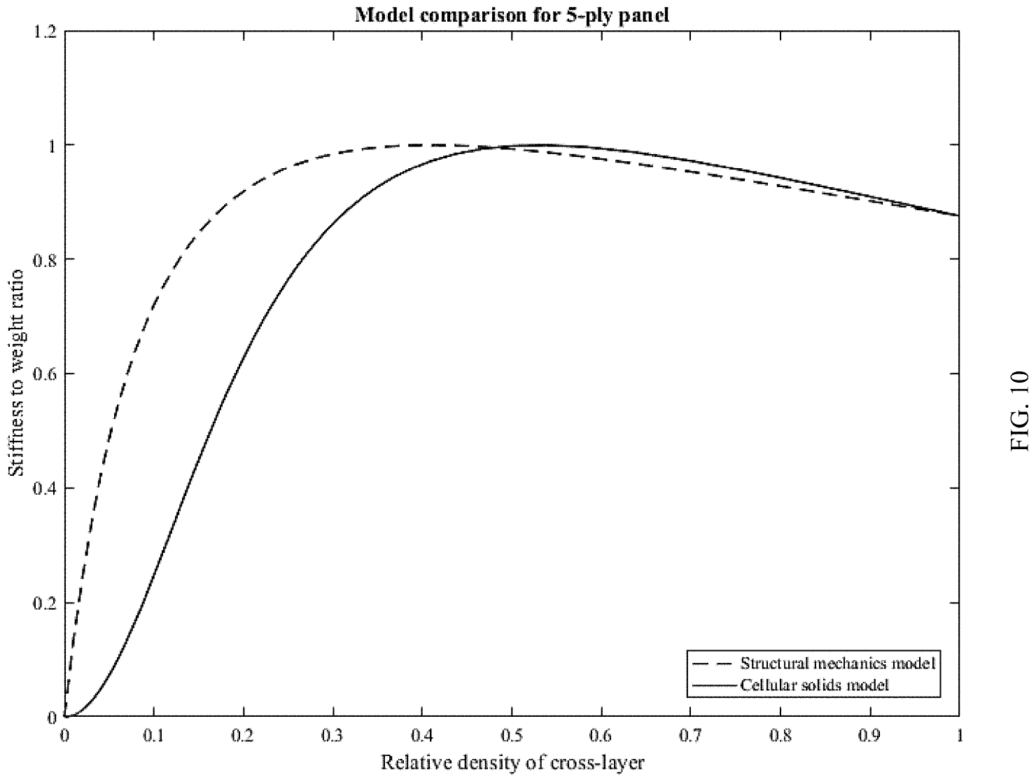

From the above-results, it was demonstrated that the two models provide results that generally agree. Both models predict an optimal stiffness-to-weight ratio for a relative core (i.e. inner layer) density of the transverse/cross-layers of less than 1. The models also predicted two different regions: a plateau (around the optimal relative density of the inner layers), followed by a sharp drop. Beyond a basic agreement of the trends, however, the predictions of the optimum relative density of the inner layers are different, with the structural mechanics model showing a peak at 0.41 while the cellular solids (honeycomb) model gives a peak at 0.53 for the 5-ply panel. Yet, the optimal solutions are in a relatively flat part region of the graphs. To compare the results of the two models, the predictions for the stiffness to weight ratio were plotted together as shown in FIG. 10. For clarity, only the results for the 5-ply CLT panels will be discussed, since the results show the same trend across the range of 3- to 11-ply included in each model.

It was determined that a key limitation of the cellular solids model is the definition of the vertical cell wall elasticity of the rectangular honeycomb core/inner layers. In the honeycomb model, the vertical cell walls are deformed in bending. In CLT panels of the present invention, the transverse/cross-layers are mainly deformed in rolling shear. This was only partly captured by defining the cell walls with different modulus of elasticity. Additionally, the theory of cellular solids assumes a small cell size relative to the size of the honeycomb, which is not completely accurate in the CLT panels of the present invention. The “honeycomb core” of the CLT panel model is only a few cells high. While both models align qualitatively, the structural mechanics model was judged to be more accurate, and thus forms the basis for the following analysis.

### Physical Load Testing

The physical load testing results are provided in FIG. 11. These results show that the reduction of stiffness and weight were comparable to the ones predicted by the models. Two types of 5-ply panels were tested: a standard CLT panel (i.e., a conventional CLT panel without any inner layer portions removed) and an optimized panel in accordance with the present invention with a core density of the transverse/cross-layers of 0.5. Three specimens of each types were load tested to failure.

The optimized panels were 21.8% lighter than the standard panels for an 8.1% reduction of stiffness. Two outliers were not considered: one of the optimized panels failed at a lower load, and one of the standard panels was much stiffer than the two others. All the numerical values for stiffness, weight, and failure load are shown in Table 4 and Table 5. However, the optimized panels also have a load capacity 31.2% lower. The standard and optimized panels displayed different failure modes—the standard panels experienced a face rupture of the wood on the tension side of the panels, and the optimized panels failed by delamination, a rupture of the bond at the cross-layer interface, as expected from a shear failure.

TABLE 4
Weight averages of the specimen tested.

| Panel | FULLs | OPTIs | Reduction |
|---|---|---|---|
| Weight [gr] | 3724 | 2910 | 21.8% |

TABLE 5
Results of the load tests. Failure force (N) and vertical stiffness (N/mm)
measured at mid-span.

| | | | | Average | | | | | |
|---|---|---|---|---|---|---|---|---|---|
| | | | | (Average | | | | | |
| | | | | without | | | | | |
| Panel | FULL1 | FULL2 | FULL3 | outlier) | OPTI1 | OPTI2 | OPTI3 | Average | Reduction |
| Failure load | 2440 | 2290 | 2779 | 2503 | 2032 | 2018 | 1115 | 1712 | 31.2% |
| [N] | (2440) | (2290) | (x) | (2365) | (2032) | (2018) | (x) | (2025) | (16.8%) |
| Vertical | 50 | 48.6 | 57.2 | 51.9 | 46 | 45.2 | 42.5 | 44.6 | 14.2% |
| Stiffness | (50) | (48.6) | (x) | (49.3) | (46) | (45.2) | (x) | (45.6) | (8.1%) |
| [N/mm] | | | | | | | | | |
| (measured | | | | | | | | | |
| between 100 N | | | | | | | | | |
| and 500 N) | | | | | | | | | |

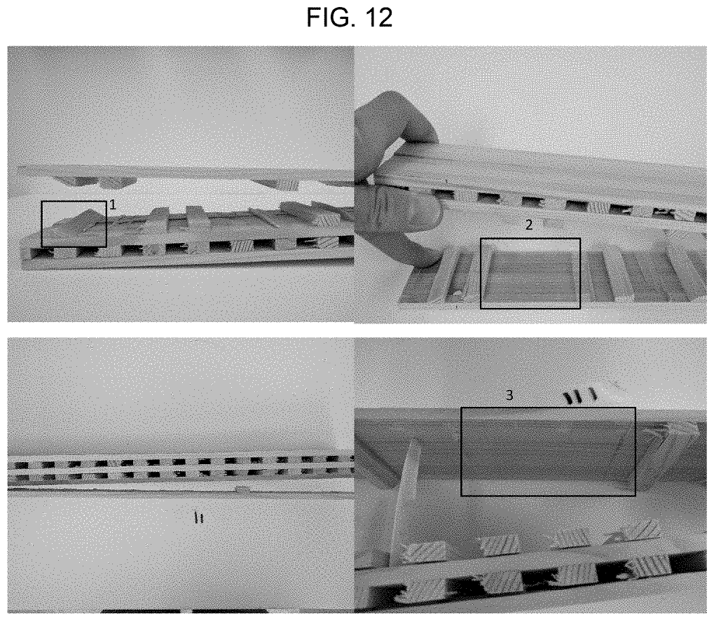

Poor glue bonding between the CLT panel layers due to an uneven contact surface can explain the early delamination failure of one of the optimized CLT panels (‘OPTI3’). It can be seen in FIG. 12 that the layers were not entirely planed down to the same height, which prevented the layers from fully bonding.

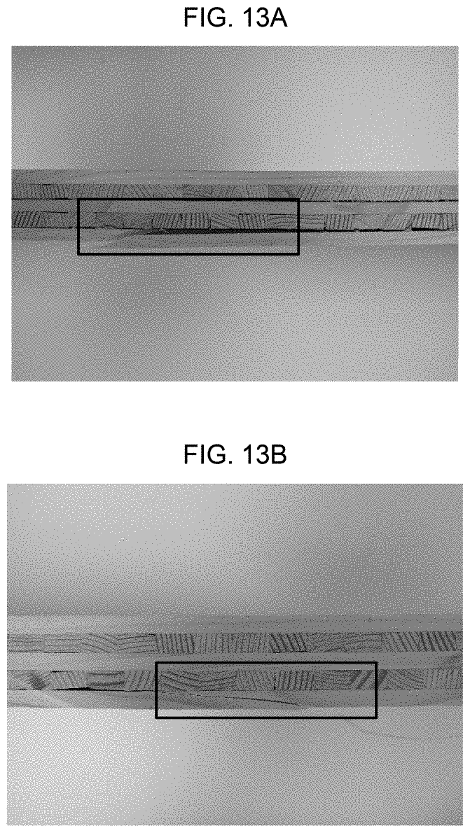

FIG. 12 shows the failure of the three optimized CLT panels. Each failed by delamination. It is important to notice that for most of the optimized CLT panels, signs of bad bond or contact surface for the glue are visible. When the bond was sufficient, the glue was stronger than the wood itself, as can be seen in box 1 of FIG. 12. As shown, the standard CLT panels experienced a face rupture on the tension side of the panel due to bending (FIGS. 13A-B).

The effect of the poor glue bond was especially obvious when the cross-layer showed no sign of wood rupture but only had a negative influence on one of the optimized CLT panels. The poor glue bond was not as critical for the standard panels due to the redundancy of the cross layer. Nevertheless, these tests make it clear that the effectiveness of optimized CLT panels in building applications is dependent upon careful construction to ensure that failure is controlled by the material properties rather than issues of quality.

Following the analysis and load testing of the behavior of optimized CLT panels having core variable density (i.e., having one or more portions of the inner layer(s) removed), the model was taken a step further and was used to run a layout optimization of present invention CLT panels.

### CLT Panel Layout Optimization

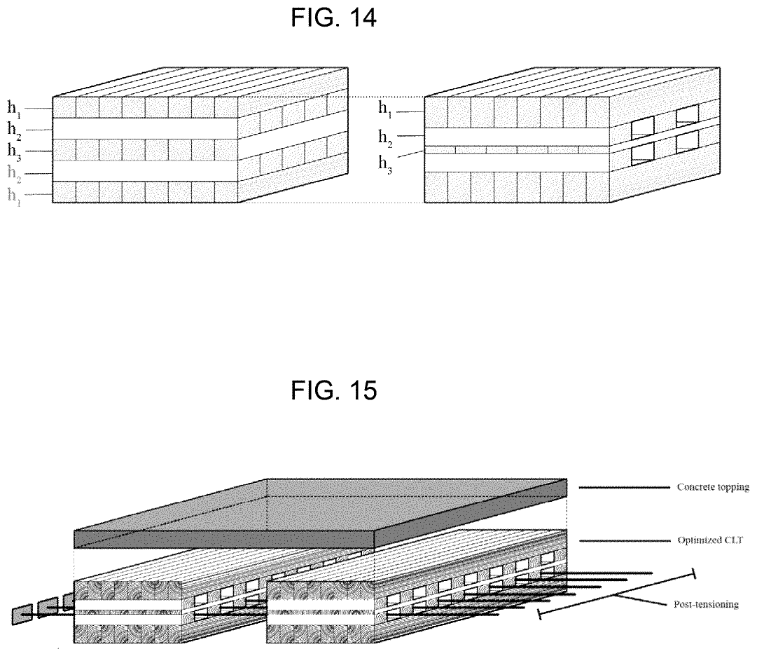

This section describes material saving opportunities from the layout optimization of 5-ply CLT panels of the present invention for a range of different spans. Optimization was performed such that the overall height of the optimized CLT panel was maintained the same as a standard CLT panel (see FIG. 14, wherein the standard CLT panel is shown on the left with all layers having equal thickness and no inner layers having removed portions and the optimized CLT panel is shown on the right), and then portions of inner transverse/cross-layers were removed while modifying individual layer thicknesses, while also maintaining stiffness of the optimized CLT panel the same as the standard CLT panel.

The transverse/cross-layers were also assigned a relative density parameter. In all the cases, the standard cross-section of the CLT panel, defined as the initial condition, sets the target stiffness. Here, the 5-ply standard CLT panel, as schematically illustrated in FIG. 14 (left, having no portions of inner layer(s) removed and having all layers of equal heights), had a total structural depth of 175 mm with three longitudinal layers and two cross-layers. The parameter a was set to 99%, the bounds for the layer thicknesses for h₁, h₂ and h₃ were 12.7 mm≤h≤152.4 mm and the bounds of the relative density of the cross layer (h₂) were 0.2≤ρ*≤1.0.

As shown in FIG. 14 (right), the layer thicknesses of the present invention optimized CLT panel were h₁=51.2 mm, h₂=29.7 mm, h₃=12.7 mm, with a relative density of ρ*=0.47. This optimized CLT panel (right) layout achieved the same stiffness as the standard CLT panel (left) but required 18% less material than the standard CLT panel.

The same model can be run for a variety of target stiffness values. When the value of a is set to lower values, the final CLT panel stiffness will decrease. If larger displacements are acceptable, or if the CLT panel chosen for the application is stiffer than necessary, larger material savings can be achieved.

Thus, the present invention layout optimization addresses the stiffness reduction resulting from the introduction of cavities/holes in inner layers of CLT panels. While this adds some complexity to the manufacturing process, an optimized CLT panel having (1) the same or similar total height (wherein the same or similar height would include a variation of height of up to about 20%) (2) the same or substantially the same stiffness (wherein a variation in stiffness may be acceptable in certain as discussed above), and (3) reduced weight can be provided. (noting that (1)-(3) are values of the present optimized CLT panel in comparison to a standard CLT panel without removed portions/cavities/holes and without varying layer thickness)

Thus, the present invention provides a CLT panel, method of making, and system for optimizing a CLT panel wherein the material consumption can be reduced without a substantial loss of performance. In the exemplary 5-ply CLT panel, material consumption was reduced by 18%. Further reduction of material consumption can also be achieved using the present optimization methods. In the case of fewer ply CLT panels, the reduction of materials will generally be lower, while increased ply CLT panels will provide opportunities for even further material reduction. In particular, the methodology for optimization is the same for any number of panel layers. Since only the transverse/cross-layers are modified, there will be a greater influence for CLT panels with more layers. In cases where performance trade-offs are acceptable (e.g., if a decrease in stiffness, strength, and/or overall cross-sectional height is acceptable), further weight reduction may be achieved as well as increased material savings. If desired, another mechanism to increase material savings would be to provide removed portions of one or more inner longitudinal layers. The addition of holes/cavities (“removed portions”) in CLT panel inner layers and, if desired, a change of layer thicknesses provides increased performance. Further, the two new parametric models developed herein detail the relationship between the material savings and the stiffness variation due to the present invention CLT panel modifications. These models may be used to design more efficient CLT panels for floor systems of ubiquitous timber buildings.

As outlined, material costs in CLT manufacturing are responsible for at least 52%, and even up to 80%, of the total CLT manufacturing costs. The present structure and methods can reduce the material consumption and weight of the CLT structural elements without significant changes in the structural properties of the CLT. Material consumption and weight of the CLT panel can be reduced from about 20% up to around 50% (depending upon the acceptable performance parameters), which can translate into significant savings in manufacturing costs (e.g., 10 to 15% without changes to the structural quality of the CLT products, and up to about 25 to 38% in the case where performance trade-offs are acceptable) Furthermore, the reduction of the weight of CLT panels will have positive effects on the design of building structures. The reduced material consumption and cost of the proposed optimized CLT panels can help mitigate the ecological impact of the construction industry, while offering a new competitive building product to the market.

Both the structural mechanics model and square honeycomb model can be used for the design of full-scale CLT panels. Further, the present invention CLT panels provide beneficial opportunities to use the created cavities within the CLT panel for different purposes, such as, for example, using these cavities in the transverse/cross-layers to run building services or to introduce post-tensioning elements in the transverse direction. Together with a concrete topping slab, a post-tensioning system in the cross-layers could create an efficient two-way system, reduce the risk of vibration, and increasing the thermal mass of the floor (see, e.g., FIG. 15).

According to further embodiments of the present invention, one or more of the inner layers, particularly the inner transverse/cross-layers, are modified with constant relative density parameters over the whole length of the element. By modifying the transverse/cross-layers so as to adapt to the moment and shear distributions, greater material savings could be achieved. In particular, this could be achieved by using a longitudinal discretization of the model, considering the external loads and a varying relative density along the length of the panel (in other words, removing more of the transverse/cross-layer at the center portion of the CLT panel, for example, and removing less around the supports/ends of the CLT panel). Another technique, such as topology optimization, could also be used to find the distribution of the cross-layers based on the loading conditions. In this case, the CLT panel would be modeled as a multi-layer truss with diagonals representing the anisotropic behavior of the cross-layers.

Furthermore, the development of advanced manufacturing techniques, such as robotic fabrication in architecture, could enable the mass-customization of structural elements for the building sector. With the option to customize every design according to the present invention, a parametric manufacturing process could be a direct physical translation of the computational models. Each element could be designed for its end application, taking into account the loading conditions, availability of materials and more. Coupled with structural optimization, advanced manufacturing techniques could help reduce the environmental footprint of the building sector. Even within more conventional manufacturing processes, the ability to customize material placement within a CLT panel could lead to savings in standardized systems, so that CLT panels of the present invention, for given spans and depths, could have fixed amounts of material removed.

The present method for optimization may be performed by a system, such as a computer, containing a processor, a storage device, a memory having software stored therein that defines the abovementioned functionality, input and output (I/O) devices (or peripherals), and a local bus, or local interface allowing for communication within the computer. The local interface can be, for example but not limited to, one or more buses or other wired or wireless connections, as is known in the art. The local interface may have additional elements, such as, for example, controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in the memory. The processor can be any custom made or commercially available single core or multi-core processor, a central processing unit (CPU), an auxiliary processor among several processors associated with the present system, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remotely from one another, but can be accessed by the processor.

The software defines functionality performed by the system, in accordance with the present invention. The software in the memory may include one or more separate programs, each of which contains an ordered listing of executable instructions for implementing logical functions of the system, as described below. The memory may contain an operating system (O/S). The operating system essentially controls the execution of programs within the system and provides scheduling, input-output control, file and data management, memory management, and communication control and related services.

The I/O devices may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate via both inputs and outputs, for instance but not limited to, a modulator/demodulator (modem; for accessing another device, system, or network), a radio frequency (RF) or other transceiver, a telephonic interface, a bridge, a router, or other device. When the system is in operation, the processor is configured to execute the software stored within the memory, to communicate data to and from the memory, and to generally control operations of the system pursuant to the software, as explained above.

When the functionality of the system is in operation, the processor is configured to execute the software stored within the memory, to communicate data to and from the memory, and to generally control operations of the system pursuant to the software. The operating system is read by the processor, perhaps buffered within the processor, and then executed.

When the system is implemented in software, it should be noted that instructions for implementing functions of the system can be stored on any computer-readable medium for use by or in connection with any computer-related device, system, or method. Such a computer-readable medium may, in some embodiments, correspond to either or both the memory or the storage device. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system is implemented in hardware, the system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 16 is a flowchart illustrating steps taken by the software stored within the computer, in accordance with the present invention. As shown by block 1002, the software first allows the user to define model parameters. Such model parameters may include panel height, panel span, a number of plys, and loading conditions. As shown by block 1004, the software then allows the user to define material parameters. Such material parameters may include bending strength, tensile strength, compressive strength, elastic modulus parallel to fiber direction, shear strength, and shear stiffness. As shown by block 1006, the software then allows the user to define optimization parameters. Such parameters may include a stiffness modifier (alpha), initial panel layer heights, initial core relative density (rho), upper and lower bounds for panel layer heights and core relative density, and minimum external thickness for fire resistance.

As shown by block 1008 the present system then calculates an initial bending stiffness based on equation 9, previously provided. Model parameters, material parameters, and certain defined optimization parameters, such as, for example, stiffness modifier, initial panel height, upper and lower bounds, and minimum external thickness for fire resistance, are used in the calculation of the initial bending stiffness.

To determine an optimal design of the panels, an optimization loop is run by the software. To determine the optimal design of the panels, the system modifies the individual panel layer heights and relative core density as shown by block 1010. The system then computes the bending stiffness based on equation 9 again, as well as determining constraints equations based on equations 13-17 (block 1012). As shown by block 1014, the system then determines if the design requirements are met by comparing the current value of the iteration with the limit values of the constraints using the inequality equations 13-17.

The optimization loop continues to run in determining if the design requirements are met. If they are not met, the individual panel layer heights and relative core density are again modified (block 1010). Alternatively, if the design requirements are met the optimal design is found (block 1016).

What is claimed is:

1. A method of forming a cross-laminated timber (CLT) panel, the method comprising the steps of:
providing a top timber layer, the top timber layer having a wood grain running along a length of the CLT panel;
providing at least one inner timber layer disposed directly beneath the top timber layer, the at least one inner timber layer having a wood grain running perpendicular to the length of the CLT panel;
providing a bottom timber layer disposed directly beneath the at least one inner timber layers, the bottom timber layer having a wood grain running along the length of the CLT panel;
wherein the at least one inner timber layer is sandwiched between the top timber layer and the bottom timber layer;
wherein the at least one inner timber layer comprises a plurality of components, the plurality of components being spaced apart from each other within the at least one inner layer; and
wherein a thickness of the at least one inner timber layer is different from a thickness of at least one of a thickness of the top timber layer and a thickness of the bottom timber layer.

2. The method of claim 1, wherein the method further comprises including an air gap between the plurality of components.

3. The method of claim 2, the method further comprising including a filler element in the air gap.

4. The method of claim 2, the method further comprising including a reinforcing element in the air gap.

5. The method of claim 1, wherein the step of providing at least one inner timber layer comprises providing three inner timber layers, wherein a first inner timber layer is disposed directly beneath the top timber layer, a second inner timber layer is disposed directly beneath the first inner timber layer, and a third inner timber layer is disposed directly beneath the second inner timber layer and above the bottom timber layer,
the first inner timber layer having wood grain running perpendicular to the length of the CLT panel, the second wood inner timber layer having wood grain running along the length of the CLT panel, and the third inner timber layer having wood grain running perpendicular to the length of the CLT panel; and
wherein the first inner timber layer comprises the plurality of components and wherein the third inner timber layer comprises the plurality of components.

6. The method of claim 1, wherein the plurality of components are numbered, sized and/or spaced so as to provide a CLT panel having an increased stiffness to weight ratio as compared to a CLT panel in which all inner timer layers comprise a single solid timber structure extending throughout the entire length and an entire width of the CLT panel, the stiffness to weight ratio calculated according to equations (6)-(12) below:
$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness \text{:} {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness \text{:} {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness \text{:} {EI}_{app} = \frac{{EI}_{eff}}{1 + \frac{{K}_{s} {EI}_{eff}}{{GA}_{eff} {L}^{2}}} & ( 9 ) \\ Bending strength \text{:} {F}_{b} {S}_{eff} = {F}_{b} \frac{2 {EI}_{eff}}{{E}_{1} h} & ( 10 ) \\ Shear strength \text{:} {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight \text{:} w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$
where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions, F_{b}=allowable bending stress, E₁=stiffness parallel to the wood grain and F_{S}=allowable rolling shear stress.

7. A cross-laminated timber (CLT) panel comprising:
a top timber layer, the top timber layer having a wood grain running along a length of the CLT panel;
at least one inner timber layer disposed directly beneath the top timber layer, the at least one inner timber layer having a wood grain running perpendicular to the length of the CLT panel;
a bottom timber layer disposed directly beneath the at least one inner timber layers, the bottom timber layer having a wood grain running along the length of the CLT panel;
wherein the at least one inner timber layer is sandwiched between the top timber layer and the bottom timber layer;
wherein the at least one inner timber layer comprises a plurality of components, the plurality of components being spaced apart from each other within the at least one inner layer; and
wherein a thickness of the at least one inner timber layer is different from a thickness of at least one of a thickness of the top timber layer and a thickness of the bottom timber layer.

8. The CLT panel of claim 7, wherein the at least one inner timber layer comprises three inner timber layers, wherein a first inner timber layer is disposed directly beneath the top timber layer, a second inner timber layer is disposed directly beneath the first inner timber layer, and a third inner timber layer is disposed directly beneath the second inner timber layer and above the bottom timber layer;
wherein the first inner timber layer having wood grain running perpendicular to the length of the CLT panel, the second wood inner timber layer having wood grain running grain running along the length of the CLT panel, and the third inner timber layer having wood grain running perpendicular to the length of the CLT panel; and
wherein the first inner timber layer comprises the plurality of components and wherein the third inner timber layer comprises the plurality of components.

9. The CLT panel of claim 7, wherein the plurality of components are numbered, sized and/or spaced so as to provide a CLT panel having an increased stiffness to weight ratio as compared to a CLT panel in which all inner timer layers comprise a single solid timber layer extending throughout the entire length and an entire width of the CLT panel, the stiffness to weight ratio calculated according to equations (6)-(12) below:
$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness \text{:} {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness \text{:} {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness \text{:} {EI}_{app} = \frac{{EI}_{eff}}{1 + \frac{{K}_{s} {EI}_{eff}}{{GA}_{eff} {L}^{2}}} & ( 9 ) \\ Bending strength \text{:} {F}_{b} {S}_{eff} = {F}_{b} \frac{2 {EI}_{eff}}{{E}_{1} h} & ( 10 ) \\ Shear strength \text{:} {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight \text{:} w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$
where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions, F_{b}=allowable bending stress, E₁=stiffness parallel to the wood grain and F_{S}=allowable rolling shear stress.

10. The CLT panel of claim 8, wherein the plurality of components are numbered, sized and/or spaced so as to provide a CLT panel having an increased stiffness to weight ratio as compared to a CLT panel in which all inner timer layers comprise a single solid timber layer extending throughout the entire length and an entire width of the CLT panel, the stiffness to weight ratio calculated according to equations (6)-(12) below:
$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness : {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness : {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness : {EI}_{app} = \frac{{EI}_{eff}}{1 + \frac{{K}_{s} {EI}_{eff}}{{GA}_{eff} {L}^{2}}} & ( 9 ) \\ Bending strength : {F}_{b} {S}_{eff} = {F}_{b} \frac{2 {EI}_{eff}}{{E}_{1} h} & ( 10 ) \\ Shear strength : {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight : w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$
where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions, F_{b}=allowable bending stress, E₁=stiffness parallel to the wood grain and F_{S}=allowable rolling shear stress.

11. A system of optimizing a CLT panel according to claim 7 comprising:
varying the number size and/or spacing of the plurality of components and performing the calculations according to equations (6)-(12) below for each variation:
$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness : {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness : {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness : {EI}_{app} = \frac{{EI}_{eff}}{1 + \frac{{K}_{s} {EI}_{eff}}{{GA}_{eff} {L}^{2}}} & ( 9 ) \\ Bending strength : {F}_{b} {S}_{eff} = {F}_{b} \frac{2 {EI}_{eff}}{{E}_{1} h} & ( 10 ) \\ Shear strength : {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight : w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$
where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions, F_{b}=allowable bending stress, E₁=stiffness parallel to the wood grain and F_{S}=allowable rolling shear stress, until an increased stiffness to weight ratio is achieved as compared to a CLT panel in which all inner timer layers comprise a single solid timber layer extending throughout the entire length and an entire width of the CLT panel.

12. A system of optimizing a CLT panel according to claim 8 comprising:
varying the number size and/or spacing of the plurality of components and performing the calculations according to equations (6)-(12) below for each variation:
$$\begin{matrix} {( \frac{{ρ}^{*}}{{ρ}_{s}} )}_{i} = \{ \begin{matrix}0 if i uneven \\ ( \frac{{ρ}^{*}}{{ρ}_{s}} ) if i even \end{matrix} & ( 6 ) \\ Effective bending stiffness : {EI}_{ef} = {\sum }_{i = 1}^{n} {( \frac{{ρ}^{*}}{{ρ}_{s}} )}_{i} {E}_{i} {b}_{i} \cdot \frac{{h}_{i}^{3}}{12} + {\sum }_{i = 1}^{n} {( \frac{{ρ}_{ }^{*}}{{ρ}_{s}} )}_{i} {E}_{i} {A}_{i} {z}_{i}^{2} & ( 7 ) \\ Effective shear stiffness : {GA}_{eff} = \frac{{a}^{2}}{⌈ ( \frac{{h}_{1}}{2 {G}_{1} {b}_{1}} ) + ( {\sum }_{i = 2}^{n - 1} \frac{{h}_{i}}{{G}_{i} {b}_{i}} {( \frac{{ρ}_{ }^{*}}{{ρ}_{s}} )}_{i} ) + ( \frac{{h}_{n}}{2 {G}_{n} {b}_{n}} ) ⌉} & ( 8 ) \\ Apparent bending stiffness : {EI}_{app} = \frac{{EI}_{eff}}{1 + \frac{{K}_{s} {EI}_{eff}}{{GA}_{eff} {L}^{2}}} & ( 9 ) \\ Bending strength : {F}_{b} {S}_{eff} = {F}_{b} \frac{2 {EI}_{eff}}{{E}_{1} h} & ( 10 ) \\ Shear strength : {F}_{s} ( \frac{Ib}{{Q}_{eff}} ) = ( \frac{{ρ}_{ }^{*}}{{ρ}_{s}} ) {F}_{s} \frac{{EI}_{eff}}{{\sum }_{i = 1}^{n / 2} {E}_{i} {h}_{i} {{z}_{i} ( \frac{{ρ}_{ }^{*}}{{ρ}_{s}} )}_{i}} & ( 11 ) \\ Normalized weight : w = \frac{( \frac{( \# ply - 1 ) ( \frac{{ρ}_{ }^{*}}{{ρ}_{s}} )}{2} + \frac{\# ply + 1}{2} )}{\# ply} & ( 12 )\end{matrix}$$
where bᵢ=width of the layer, Eᵢ=stiffness of the layer, hᵢ=thickness of the layer, zᵢ=distance from the neutral axis to the center of the layer, Aᵢ=area of the layer, a=distance between the center of the two extreme layers, Gᵢ=rolling shear stiffness of the layer, Kₛ=constant representing the loading and fixities conditions, F_{b}=allowable bending stress, E₁=stiffness parallel to the wood grain and F_{S}=allowable rolling shear stress, until an increased stiffness to weight ratio is achieved as compared to a CLT panel in which all inner timer layers comprise a single solid timber layer extending throughout the entire length and an entire width of the CLT panel.
